(19) United States
(12) Patent Application Publication
(10) Pub. No.: US 2024/0411275 A1
(43) Pub. Date: Dec. 12, 2024

(54) LUMINOUS TIMEPIECE DISPLAY USING OPTICAL COUPLING VIA MICROSTRUCTURES

(71) Applicant: The Swatch Group Research and Development Ltd, Marin (CH)

(72) Inventor: Cyrille GERNEZ, Boudry (CH)

(73) Assignee: The Swatch Group Research and Development Ltd, Marin (CH)

(21) Appl. No.: 18/611,861

(22) Filed: Mar. 21, 2024

(30) Foreign Application Priority Data
Jun. 12, 2023 (EP) 23178675.7

(51) Int. Cl. G04G 9/00; G04B 19/30

(52) U.S. Cl. CPC G04G 9/0041; G02B 6/0016; G02B 6/0068; G02B 6/0073; G02B 6/0083; G04B 19/30

(57) ABSTRACT

A display device (100) for a watch (1000) including at least one light source (200) and including, between a dial (300) carrying at least one reference scale on a top side (301) and a crystal (400) on the side facing the user a set of hands (10) coaxial about an axis of rotation (D) including at least a first luminous indicator (1) including a first light guide (11) arranged to diffuse some of the light emitted by said at least one light source (200), wherein the first light guide (11) includes first coupling microstructures (110) which are arranged to allow light to enter the first light guide (11) and/or to allow light to exit the first light guide (11).

### CROSS REFERENCE TO RELATED APPLICATIONS

This application is claiming priority based on European Patent Application No. 23178675.7 filed on Jun. 12, 2023.

### TECHNICAL FIELD OF THE INVENTION

The invention relates to a watch display device including at least one light source and including, between a dial carrying at least one reference scale on a top side and a crystal on the side facing the user, a set of hands coaxial about an axis of rotation and including at least a first luminous indicator including a first light guide arranged to diffuse part of the light emitted by said at least one light source.

The invention relates to the field of displays for timepieces, in particular watches, and more particularly to luminous displays.

### TECHNOLOGICAL BACKGROUND

EP19220169 describes the principle of hand illumination using several light sources. A first source, typically an LED, or a group of LEDs, remotely excites a secondary source, in particular a dot containing fluorescent pigments placed under the hands. The emission spectra of the primary source and the excitation spectra of the secondary source must thus match for the system to be effective. This limits the choice to LEDs that emit sufficiently around 400 nm. Fluorescent pigments have their maximum absorption peaks in ultraviolet wavelengths. The same document further describes the presence of apertures in the head of the hour hand to allow light to pass through to the minute hand, which obviously complicates the manufacture of such a hand.

### SUMMARY OF THE INVENTION

The purpose of the invention is to develop luminous indicators for timepieces, for display at night or in poorly lit environments, with an alternative to the fluorescent or phosphorescent coatings of the prior art.

To this end, the invention relates to a display device according to claim 1.

### BRIEF DESCRIPTION OF THE FIGURES

The purposes, advantages and features of the invention will be better understood upon reading the following detailed description given with reference to the accompanying drawings, in which:

FIG. 1 is a diagrammatic, sectional view of a first alternative embodiment of a hand according to the invention, taken through the axis of rotation of said hand;

FIG. 2 is a diagrammatic, sectional view of a second alternative embodiment of the hand according to the invention, taken through the axis of rotation of said hand;

FIG. 3 is a diagrammatic, sectional view of a coaxial set of hands according to the invention, showing two superimposed hands and taken through the common axis of rotation said hands;

FIG. 4 is a diagrammatic, sectional view of a watch including a coaxial set of hands according to the invention, showing two superimposed hands illuminated by a lower light source and taken through the common axis of rotation of said hands.

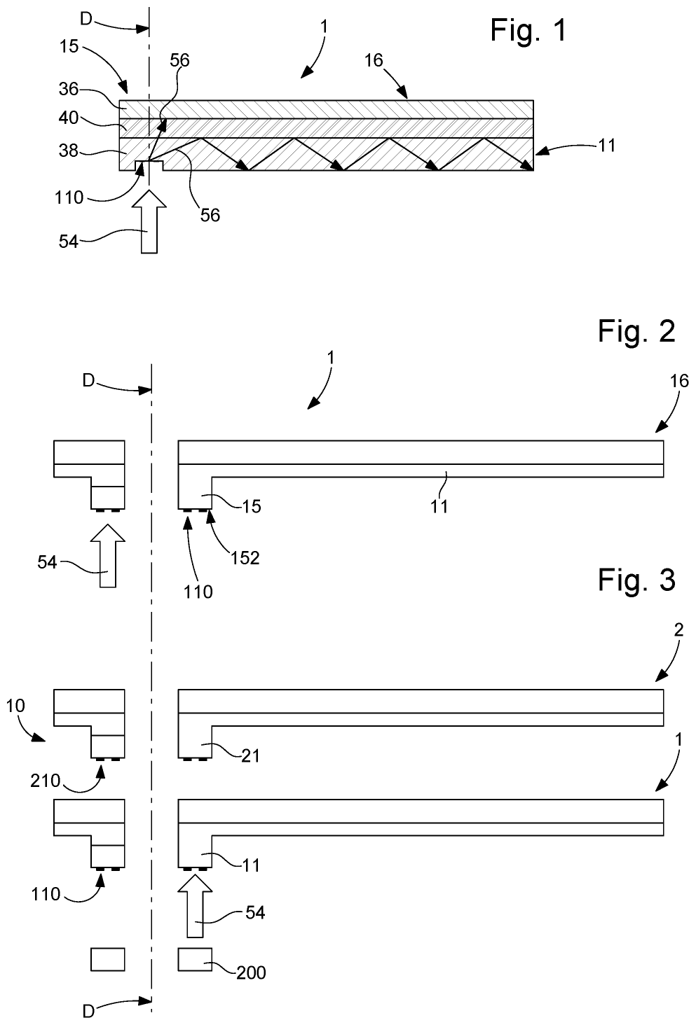

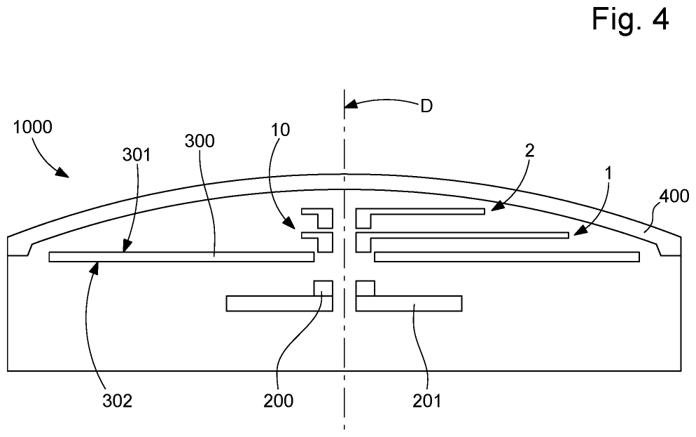

### DETAILED DESCRIPTION OF THE INVENTION

The invention relates to a luminous timepiece display using optical coupling via microstructures.

EP3845974A1, incorporated herein as a reference, describes a movable indicator for an analogue display device, in particular a watch display device comprising one or more movable indicators such as hands. The indicator comprises a multi-layered part including an opaque metal layer and a transparent light guide layer, and forming a body and a head of the indicator. The head is centred relative to an axis of rotation of the indicator and arranged to receive a luminous flux on its lower face facing away from the user. A fluorescent material is arranged on the transparent light guide layer at the head of the indicator to absorb at least part of this luminous flux, and to re-emit a second fluorescent luminous flux into the transparent light guide layer.

More particularly, the display device according to this document EP3845974A1 includes a dial, and such indicators arranged above the dial, i.e. on the watch crystal side, and visible to the user, the respective heads of the indicators being superimposed and fastened to respective arbors to rotate about a common axis of rotation, and this device includes a stationary source of illumination, which is arranged to illuminate from below, i.e. on a bottom side of the dial facing away from the user and invisible thereto except in the case of a skeleton or mysterious watch, all of the heads of the indicators by means of a luminous flux substantially parallel to the common axis of rotation and having a wavelength shorter than the wavelength re-emitted by the fluorescent material. The stationary source of illumination can include light-emitting diodes, hereinafter referred to as LEDs, and/or organic LEDs, which are distributed around said arbors and mounted on a printed circuit element, hereinafter referred to as a PCB, arranged below the dial, or miniature laser sources of the VCSEL type, similarly arranged.

On a similar basis, and alternatively, the invention suggests producing a watch display including at least one luminous hand, in particular by optical coupling via microstructures. Because of the presence of the microstructures, this luminous hand can be simpler than that described in detail in EP3845974A1, which necessarily includes a fluorescent material, thus making it possible to reduce the cost of the hand.

A particular aim of this invention is to illuminate the hands of a watch on demand without using electrical wiping contacts.

The first proposal relates to the hour hand. On some hands, the hand head is not very developed in relation to the hand body, or even almost non-existent, i.e. there is no widening around the hole in relation to the hand body; there is thus no impediment to the flow of light towards the minute hand. Such a design avoids the need to create apertures and the need to manufacture a complex design; the only thing to avoid is direct light leaks when viewed from the side or at a grazing angle.

A second proposal relates to the coupling of light into the light guide included in the hands. In the same way that light can exit the light guide by means of structures that change its path (prisms or cones, for example), the same type of structures can be used to bring light into the guide from the LEDs, which are in particular positioned on a PCB located under or on the dial, or forming the dial.

This further applies to simple surface etching, which modifies the surface roughness. So, rather than depositing a fluorescent ink that complicates the process, it is possible to etch coupling structures at the same time as extraction structures directly into a master used to replicate these structures on the light guide of the hand.

In the usual case of a set of hands including a plurality of hands, several options can be chosen.

A first option is to standardise the luminosity of at least two neighbouring hands, and to this end different coupling zone designs (surface, shape, depth) must be considered. Providing a sufficiently large coupling surface for the minute hand ensures continuous luminous coupling on this hand, despite the presence of the hour hand in the light path.

The use of a fluorescent pigment in certain luminous hands is often hindered by the colour difference produced between the two neighbouring hands. Even though a large proportion of the light coupled into the light guide comes from the fluorescent dot, some of it can be coupled without any special device, for example via the edges of the guide. This involves a mixing of colours between the light emitted by the fluorescent pigments and the original light from the LEDs. UV LEDs, for example, also emit blue light. This mixing of colours, which is difficult to control and which differs between the hour and minute hands, does not exist if coupling occurs via microstructures, since there is no change in colour via these microstructures.

Another alternative embodiment is to take advantage of this effect to have hands of different colours. This can be done by accentuating the mixture of colours between the fluorescents and the primary colours of the LEDs, although this is difficult to control. More simply, fluorescent dots emitting different colours can be used.

Another alternative embodiment involves replacing the fluorescent material with a phosphorescent material. After a short period of excitation, the user will see only the phosphorescent light and thus the same colour on both hands. This approach can also be advantageous in terms of maximising the duration of the luminous effect with a minimum energy balance. The ambient light seen by the watch and the hands can also be used in part to recharge the phosphorescent material and produce light in the early evening.

Thus, in order to provide a luminous display without necessarily being dependent on the use of luminescent or phosphorescent materials, which can still be used in addition to the invention for coloured alternative embodiments, the invention relates more particularly to a display device 100 for a watch 1000 including at least one light source 200 and including a set of hands 10, between a dial 300 carrying at least one reference scale on a top side 301 and a crystal 400 on the side facing the user. This set of hands 10 is movable about an axis of rotation D and, when it includes several indicators, is coaxial about this axis of rotation D. The set of hands 10 includes at least a first luminous indicator 1, including a first light guide 11 arranged to diffuse some of the light emitted by this at least one light source 200.

According to the invention, the first light guide 11 includes first coupling microstructures 110, which are arranged to allow light to enter the first light guide 11 and/or to allow light to exit the first light guide 11.

More particularly, the at least one first luminous indicator 1 includes several layers including an opaque metal layer 36 and a transparent layer 38 forming the first light guide 11, and forming a first head 15 and a first body 16, the first head 15 being centred relative to said axis of rotation D and arranged to receive a luminous flux 54 on a first lower face 152 not visible to the user. Such first coupling microstructures 110 are arranged on or in the transparent light guide layer, at the head 15, to provide the input coupling into the transparent light guide layer.

In an alternative embodiment, a fluorescent material is arranged on or in the transparent light guide layer at the head 15.

In another alternative embodiment, a phosphorescent material is arranged on or in the transparent light guide layer at the head 15.

More particularly, the coaxial set of hands 10 includes, between the first luminous indicator 1 and the crystal 400, at least a second luminous indicator 2 including a second light guide 21 arranged to diffuse some of the light emitted by the at least one light source 200 and/or by the first luminous indicator 1. The second light guide 21 includes second coupling microstructures 210, which are arranged to allow light to enter the second light guide 21 and/or to allow light to exit the second light guide 21.

More particularly, the coaxial set of hands 10 includes, between the first luminous indicator 1 and the crystal 400, a plurality of superimposed and coaxial luminous indicators, each including a light guide arranged to diffuse part of the light emitted by the at least one light source 200 and/or by the luminous indicator placed beneath it on the side facing away from the crystal 400, and each including coupling microstructures, which are arranged to allow light to enter the light guide and/or to allow light to exit the light guide.

More particularly, at least one luminous indicator, included in this coaxial set of hands 10, includes several layers including an opaque metal layer and a transparent, light guide-forming layer, and forming a head and a body, the head being centred relative to the axis of rotation D and arranged to receive a luminous flux 54 on a first lower face not visible to the user. Such coupling microstructures are arranged on or in the transparent light guide layer at the head to absorb at least part of the luminous flux and to re-emit a second luminous flux into the transparent light guide layer.

More particularly, a fluorescent material is arranged on or in the transparent light guide layer of at least one luminous indicator included in the coaxial set of hands 10, at the head to absorb at least part of the luminous flux and to re-emit a second fluorescent luminous flux into the transparent light guide layer.

More particularly, a phosphorescent material is arranged on or in the transparent light guide layer of at least one luminous indicator included in the coaxial set of hands 10, at the head to absorb at least part of the luminous flux and to re-emit a second phosphorescent luminous flux into the transparent light guide layer.

In one alternative embodiment, the interposition of a fluorescent or phosphorescent material between the light source 200 and the luminous indicator allows easy colouring, but to the detriment of the light coupling solution provided by the fluorescent material against the guide.

More particularly, the indicator closest to the crystal 400 has a coupling surface, grouping together its coupling microstructures, which is greater than the coupling surface of the indicator immediately below, on the side facing away from the crystal 400.

More particularly, at least one luminous indicator included in the coaxial set of hands 10, includes a transparent light guide layer, which is arranged to produce total internal reflection of the light rays of the second luminous flux substantially perpendicular to said axis of rotation D.

More particularly, at least one luminous indicator included in the coaxial set of hands 10, includes several layers including an opaque metal layer and a transparent, light guide-forming layer, and includes an optical insulation layer between the opaque metal layer and the transparent light guide layer. More particularly and not restrictively, an adhesive, in particular a resin, is used to assemble the metal part of the hand with the light guide part, and this adhesive or resin acts as an insulating layer, with an optical index lower than that of the light guide. The difference Δn between the refractive index of the optical insulation layer and the refractive index of the transparent light guide layer is in the range 0.1 to 0.5, inclusive. Preferably, but not exclusively, resins with an index greater than or equal to 1.1 are used for this purpose.

More particularly, the optical insulation layer has a thickness in the range 5 μm to 15 μm. This corresponds to the use of a liquid resin. For other horological applications such as pendulums or clocks, where there are fewer limitations in terms of thickness, it is possible to use film resins, the maximum thickness of which is then limited to 100 μm.

More particularly, at least one luminous indicator included in the coaxial set of hands 10 has a flat upper face and a flat lower face, perpendicular to the axis of rotation D.

More particularly, at least one luminous indicator included in the coaxial set of hands 10 has a head including a central bore in which a socket made of opaque material is arranged.

More particularly, the coaxial set of hands 10 includes, between the first luminous indicator 1 and the crystal 400, a plurality of superimposed and coaxial luminous indicators, each including a head about the axis of rotation D and a body extending substantially perpendicularly to the axis of rotation D, and a lower indicator situated closer to the dial 300 than an upper indicator situated immediately above this lower indicator, on the crystal 400 side, has at least one secondary orifice arranged around a central bore in its head, so as to allow said luminous flux to pass through the lower indicator via this at least one secondary orifice, so that at least part of the luminous flux is absorbed by the light guide of the upper indicator.

More particularly, the at least one light source 200 is positioned under the dial 300 in the vicinity of a bottom side 302 of the dial 300 facing away from the crystal 400 relative to said dial 300, or is embedded in the dial 300, or is positioned on a PCB 201 positioned under the dial 300 in the vicinity of the bottom side 302 of the dial 300.

Even more particularly, the at least one light source 200 is a stationary light source including light-emitting diodes and/or organic light-emitting diodes and/or miniature laser sources of the VCSEL type distributed around the axis of rotation D.

More particularly, at least one luminous indicator included in the coaxial set of hands 10, includes at least one luminous indicator whose light guide includes fluorescent material. The light source 200 is a stationary source of illumination arranged to illuminate, from below, all of the heads of the indicators included in this coaxial set of hands 10, by means of a luminous flux substantially parallel to the axis of rotation D and having a wavelength shorter than the wavelength re-emitted by the fluorescent material.

More particularly, at least one luminous indicator included in the coaxial set of hands 10, includes at least two luminous indicators whose light guides include fluorescent material, emitting in different colours.

The invention further relates to a watch 1000, including at least one such display device 100.

More specifically, at least one indicator included in this coaxial set of hands 10 is a luminous hand.

More specifically, at least one indicator included in this coaxial set of hands 10 is a disc.

In short, the invention allows light to be coupled directly via the microstructures. It is no longer necessary to couple light by absorption/re-emission via fluorescent material. The use of microstructures in accordance with the invention, in combination with fluorescent or phosphorescent elements, nevertheless makes it possible to obtain certain specific colour effects.

1. A display device (100) for a watch (1000) including at least one light source (200) and including, between a dial (300) carrying at least one reference scale on a top side (301) and a crystal (400) on the side facing the user, a set of hands (10) coaxial about an axis of rotation (D) including at least a first luminous indicator (1) including a first light guide (11) arranged to diffuse part of the light emitted by said at least one light source (200), wherein said first light guide (11) includes first coupling microstructures (110) arranged in the transparent layer of the first light guide, which are arranged to allow light to enter said first light guide (11) and/or to allow light to exit said first light guide (11).

2. The display device (100) according to claim 1, wherein said at least one first luminous indicator (1) comprises several layers including an opaque metal layer (36) and a transparent layer forming said first light guide (11), and forming a first head (15) and a first body (16), said first head (15) being centred relative to said axis of rotation (D) and arranged to receive a luminous flux on a first lower face (152) not visible to the user, and wherein said first coupling microstructures (110) are arranged on or in the transparent light guide layer at said head (15) to provide input coupling into said transparent light guide layer.

3. The display device (100) according to claim 1, wherein said coaxial set of hands (10) includes, between said first luminous indicator (1) and said crystal (400), at least one second luminous indicator (2) including a second light guide (21) arranged to diffuse part of the light emitted by said at least one light source (200) and/or by said first luminous indicator (1), and wherein said second light guide (21) includes second coupling microstructures (210) arranged in the transparent layer of the first light guide, which are arranged to allow light to enter said second light guide (21) and/or to allow light to exit said second light guide (21).

4. The display device (100) according to claim 1, wherein said coaxial set of hands (10) includes, between said first luminous indicator (1) and said crystal (400), a plurality of superimposed and coaxial luminous indicators, each including a light guide arranged to diffuse part of the light emitted by said at least one light source (200) and/or by the luminous indicator placed beneath it on the side facing away from said crystal (400), and each including coupling microstructures, which are arranged to allow light to enter said light guide and/or to allow light to exit said light guide.

5. The display device (100) according to claim 1, wherein at least one luminous indicator included in said coaxial set of hands (10), comprises several layers including an opaque metal layer (36) and a transparent, light guide-forming layer, and forming a head and a body, said head being centred relative to said axis of rotation (D) and arranged to receive a luminous flux on a first lower face that is not visible to the user, and wherein said coupling microstructures are arranged on or in the transparent light-guide layer at said head in order to absorb at least some of said luminous flux and to re-emit a second luminous flux into said transparent light-guide layer.

6. The display device (100) according to claim 5, wherein a fluorescent or phosphorescent material is arranged on or in the transparent light guide layer (38) of at least one luminous indicator included in said coaxial set of hands (10), at said head in order to absorb at least part of said luminous flux and to re-emit a second respectively fluorescent or phosphorescent luminous flux in the transparent light guide layer.

7. The display device (100) according to claim 1, wherein the indicator closest to said crystal (400) has a coupling surface, grouping together its coupling microstructures, which is greater than the coupling surface of the indicator immediately below, on the side facing away from said crystal (400).

8. The display device (100) according to claim 5, wherein at least one luminous indicator included in said coaxial set of hands (10), includes a transparent light guide layer (38), which is arranged to produce total internal reflection of the light rays of the second luminous flux substantially perpendicular to said axis of rotation (D).

9. The display device (100) according to claim 1, wherein at least one luminous indicator included in said coaxial set of hands (10), comprises several layers including an opaque metal layer (36) and a transparent light guide-forming layer (38), and includes an optical insulation layer (40) between said opaque metal layer (36) and the transparent light guide layer (38), and wherein the difference Δn between the refractive index of the optical insulation layer and the refractive index of the transparent light guide layer (38) is in the range 0.1 to 0.5, inclusive.

10. The display device (100) according to claim 9, wherein said optical insulation layer (40) has a thickness in the range 5 μm to 15 μm.

11. The display device (100) according to claim 1, wherein at least one luminous indicator included in said coaxial set of hands (10), includes a flat upper face and a flat lower face, perpendicular to said axis of rotation (D).

12. The display device (100) according to claim 1, wherein at least one luminous indicator included in said coaxial set of hands (10), comprises a head including a central bore in which a socket made of opaque material is arranged.

13. The display device (100) according to claim 1, wherein said coaxial set of hands (10) includes, between said first luminous indicator (1) and said crystal (400), a plurality of superimposed and coaxial luminous indicators, each including a head about said axis of rotation (D) and a body extending substantially perpendicularly to said axis of rotation (D), and wherein a lower indicator situated closer to said dial (300) than an upper indicator situated immediately above said lower indicator, on said crystal (400) side, has at least one secondary orifice arranged around a central bore in its said head, so as to allow said luminous flux to pass through said lower indicator via said at least one secondary orifice so that at least part of said luminous flux is absorbed by the light guide of said upper indicator.

14. The display device (100) according to claim 1, wherein said at least one light source (200) is positioned under said dial (300) in the vicinity of a bottom side (302) of said dial (300) facing away from said crystal (400) relative to said dial (300), or is embedded in said dial (300), or is positioned on a PCB (201) positioned under said dial (300) in the vicinity of said bottom side (302) of said dial (300).

15. The display device according to claim 14, wherein said at least one light source (200) is a stationary source of illumination which includes light-emitting diodes and/or organic light-emitting diodes and/or miniature laser sources of the VCSEL type which are distributed around said axis of rotation (D).

16. The display device (100) according to claim 1, wherein at least one luminous indicator included in said coaxial set of hands (10), includes at least one luminous indicator whose light guide includes fluorescent material, and wherein said light source (200) is a stationary source of illumination arranged to illuminate, from below, all of the heads of the indicators included in said coaxial set of hands (10) by means of a luminous flux substantially parallel to said axis of rotation (D) and having a wavelength shorter than the wavelength re-emitted by said fluorescent material.

17. The display device (100) according to claim 1, wherein at least one luminous indicator included in said coaxial set of hands (10), includes at least two luminous indicators whose light guides include fluorescent material, emitting in different colours.

18. A watch (1000) including the display device (100) according to claim 1, wherein at least one indicator included in said coaxial set of hands (10), is a luminous hand.
